(19) United States
(12) Patent Application Publication
(10) Pub. No.: US 2023/0074058 A1
(43) Pub. Date: Mar. 9, 2023

(54) ADAPTIVE AUDIO PROFILE

(71) Applicant: GM Global Technology Operations LLC, Detroit, MI (US)

(72) Inventors: Nissim Gean, Netanya (IL); Alan T. Budyta, Sterling Heights, MI (US)

(21) Appl. No.: 17/468,872

(22) Filed: Sep. 8, 2021

(51) Int. Cl. H04S 7/00

(52) U.S. Cl. CPC H04S 7/303; H04R 2499/13; H04S 2400/11

(57) ABSTRACT

An audio entertainment system includes an audio infotainment system adapted to provide sound to an environment, a plurality of speakers positioned within the environment and in communication with the infotainment system, and a controller adapted to automatically adjust output characteristics of each of the plurality of speakers based on a location of occupants within the environment.

### INTRODUCTION

The present disclosure relates to an audio entertainment system including an audio infotainment system that is adapted to provide sound to an environment. More particularly, the present disclosure discloses a system and method that automatically adjust output characteristics of each of a plurality of speakers for an infotainment system based on a location of occupants within the environment.

Often sound systems, such as within an automobile, are adapted to provide a default “best fit” audio experience, wherein the output characteristics of the speakers are adjusted under the assumption that all seats in the automobile are occupied, thus providing the best possible audio characteristics to all passengers. In the event that not all of the seats in the automobile are occupied, the driver or an occupant of the automobile must manually adjust the output characteristics of the audio system to adjust the output characteristics, such as by changing the fade control and/or balance to target a specific occupied area of the vehicle.

In addition, some output characteristics are not manually adjustable by the end user in standard audio systems. Output characteristics, such a time alignment, gain and frequency can only be adjusted manually during audio tuning. In practice, this is referred to as parametric equalization tuning. In addition, audio processing effects can be introduced/modified to improve the audio soundstage and imaging for the overall vehicle cabin. These characteristics do, however, impact the quality of the audio output at a particular location within an environment, and can be adjusted to optimize the audio for a specified zone within the environment.

Thus, while current audio entertainment systems achieve their intended purpose, there is a need for a new and improved system and method for automatically adjusting output characteristics of each of a plurality of speakers based on a location of occupants within an environment.

### SUMMARY

According to several aspects of the present disclosure, an audio entertainment system includes an audio infotainment system adapted to provide sound to an environment; a plurality of speakers positioned within the environment and in communication with the infotainment system, and a controller adapted to automatically adjust output characteristics of each of the plurality of speakers based on a location of occupants within the environment.

According to another aspect, each of the plurality of speakers includes an audio processing unit adapted to control the output characteristics of the speaker, each audio processing unit being in communication with the controller.

According to another aspect, the system further includes a plurality of seats positioned within the environment, each of the plurality of seats including a sensor adapted to detect the presence of an occupant seated therein, each of the plurality of sensors in communication with the controller, the controller adapted to receive input from the sensors within the plurality of seats to determine where occupants within the environment are seated.

According to another aspect, the controller is adapted to identify one of a plurality of pre-determined tuning zones based on the location of occupants within the environment and to adjust the output characteristics of the plurality of speakers according to a tuning profile associated with the identified tuning zone.

According to another aspect, each tuning profile provides a family of pre-set audio tuning parameter values for each of the plurality of speakers for each of the tuning zones.

According to another aspect, the environment is an interior of an automobile.

According to another aspect, the sensors within the seats are pressure sensors adapted to detect the weight of an occupant seated therein.

According to another aspect, the system further includes a seatbelt assembly associated with each of the plurality of seats within the automobile, wherein the sensors within the seats detect when the seatbelt assembly of a seat is latched.

According to another aspect, the automobile includes at least one camera mounted therein, in communication with the controller, to detect the presence of occupants within the plurality of seats.

According to another aspect, the controller is adapted to allow an occupant to selectively over-ride the automatic tuning zone selection and manually select a tuning zone.

According to several aspects of the present disclosure, a method of adapting an audio entertainment system having an audio infotainment system adapted to provide sound to a plurality of speakers positioned within an environment includes automatically adjusting, with a controller, output characteristics of each of the plurality of speakers positioned within the environment based on a location of occupants within the environment.

According to another aspect, each of the plurality of speakers includes an audio processing unit adapted to control the output characteristics of the speaker, each audio processing unit being in communication with the controller, wherein the automatically adjusting, with a controller, output characteristics of each of the plurality of speakers positioned within the environment based on a location of occupants within the environment further includes automatically adjusting, via communication between the controller and the audio processing unit for each of the plurality of speakers, output characteristics of each of the plurality of speakers positioned within the environment based on a location of occupants within the environment.

According to another aspect, the environment includes a plurality of seats positioned therein, the method further including detecting the presence of occupants within the plurality of seats with sensors positioned within each of the plurality of seats, and receiving data from the sensors, with the controller, and determining where occupants within the environment are seated, prior to automatically adjusting, with a controller, output characteristics of each of the plurality of speakers positioned within the environment based on a location of occupants within the environment.

According to another aspect, the automatically adjusting, via communication between the controller and the audio processing unit for each of the plurality of speakers, output characteristics of each of the plurality of speakers positioned within the environment based on a location of occupants within the environment further includes identifying, with the controller, one of a plurality of pre-determined tuning zones based on the location of occupants within the environment and adjusting, with the controller, the output characteristics of the plurality of speakers according to a tuning profile associated with the identified tuning zone.

According to another aspect, each tuning profile provides preset audio tuning parameter values for each of the plurality of speakers for each of the tuning zones, wherein the adjusting, with the controller, the output characteristics of the plurality of speakers according to a tuning profile associated with the identified tuning zone further includes adjusting, with the controller, the audio tuning parameter values for each of the plurality of speakers according to the pre-set audio tuning parameter values for each of the plurality of speakers for the identified tuning zone.

According to another aspect, the environment is an interior of an automobile and the sensors within the seats are pressure sensors adapted to detect the weight of an occupant seated therein, wherein the detecting the presence of occupants within the plurality of seats with sensors positioned within each of the plurality of seats further includes, detecting, with the pressure sensors, the presence of occupants within the plurality of seats.

According to another aspect, the environment is an interior of an automobile including a seatbelt assembly associated with each of the plurality of seats within the automobile, the sensors adapted to detect when the seatbelt assembly of a seat is latched, wherein the detecting the presence of occupants within the plurality of seats with sensors positioned within each of the plurality of seats further includes, detecting, with the sensors within the seats, when the seatbelt assembly of a seat is latched.

According to another aspect, the environment is an interior of an automobile including at least one camera mounted therein to detect the presence of occupants within the plurality of seats, wherein the detecting the presence of occupants within the plurality of seats with sensors positioned within each of the plurality of seats further includes, detecting, with the at least one camera, the presence of occupants within the plurality of seats.

According to another aspect, the controller is adapted to allow an occupant to over-ride the automatic tuning zone selection and manually select a tuning zone, the method further including over-riding, with the controller, the automatically selected tuning zone, when an operator manually selects, via the controller, a tuning zone.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a top schematic view of an automobile incorporating a system according to an exemplary embodiment of the present disclosure;

FIG. 2 is a schematic diagram of a system according to an exemplary embodiment of the present disclosure;

FIG. 3 is a flow chart illustrating a method according to an exemplary embodiment of the present disclosure; and

FIG. 4 is a flow chart illustrating a method according to another exemplary embodiment of the present disclosure.

### DETAILED DESCRIPTION

The following description is merely exemplary in nature and is not intended to limit the present disclosure, application, or uses.

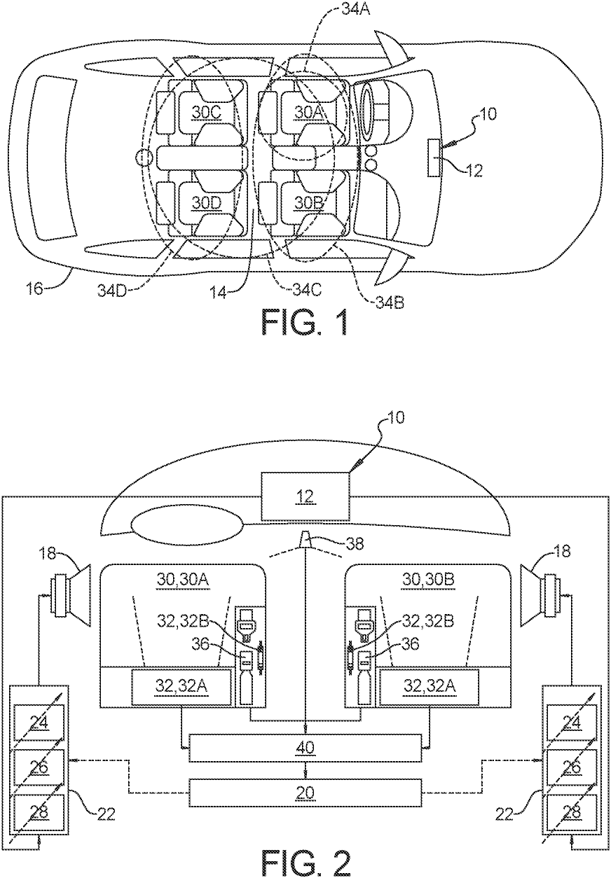

Referring to FIG. 1 and FIG. 2, an audio entertainment system 10 in accordance with the present disclosure includes an audio infotainment system 12 that is adapted to provide sound to an environment 14. As shown in the Figures, the environment 14 is the interior of an automobile 16. It should be understood that the novel aspects of the present disclosure could be applied to an audio entertainment system 10 adapted to provide sound to other environments, such as, but not limited to, an auditorium or theatre setting. For the remainder of this description, the audio entertainment system 10 will be described as applied to the interior of an automobile 16.

The audio entertainment system 10 further includes a plurality of speakers 18 positioned within the environment 14 and in communication with the infotainment system 12 and a controller 20 that is adapted to automatically adjust output characteristics of each of the plurality of speakers 18 based on a location of occupants within the environment 14. Each of the plurality of speakers 18 includes an audio processing unit 22 that is adapted to control the output characteristics of the speaker 18. Each audio processing unit 22 is in communication with the controller 20. The controller 20 sends information in the form of data to each audio processing unit 22. The data includes values that the audio processing unit 22 will use to control the output characteristics of the speakers 18. In an exemplary embodiment, the audio processing unit 22 for each speaker 18 includes a time alignment module 24, a gain module 26 and a frequency module 28. The modules 24, 26, 28 receive input from the controller 20 and adjust the time alignment, gain, and frequency output of the associated speaker 18. It should be understood that the audio processing unit 22 may also include modules adapted to control other audio processing parameters to optimize the audio listening experience for the seated occupants.

The audio entertainment system 10 further includes a plurality of seats 30 positioned within the environment 14. Each of the plurality of seats 30 includes a sensor 32 that is adapted to detect the presence of an occupant seated therein. Each of the plurality of sensors 32 is in communication with the controller 20, and the controller 20 is adapted to receive input from the sensors 32 within the plurality of seats 30 to determine where occupants within the environment 14 are seated.

In the exemplary embodiment shown in FIG. 2, the audio entertainment system 10 includes two speakers 18 and two seats 30, a driver seat 30A and a front passenger seat 30B. It should be understood, that the audio entertainment system 10 may be adapted to include any suitable number of speakers 18 and seats 30.

Referring again to FIG. 1, the controller 20 is adapted to identify one of a plurality of pre-determined tuning zones 34A, 34B, 34C, 34D based on the location of occupants within the environment 14 and to adjust the output characteristics of the plurality of speakers 18 according to a tuning profile associated with the identified tuning zone 34A, 34B, 34C, 34D.

Each tuning profile provides pre-set audio tuning parameter values, such as time alignment, gain and frequency, for each of the plurality of speakers 18 for the associated tuning zone 34A, 34B, 34C, 34D. Once the controller 20 identifies the appropriate tuning zone 34A, 34B, 34C, 34D, based on the locations of occupants within the interior of the automobile 16, the controller 20 applies the associated pre-set audio tuning parameter values and adjusts the output from each of the plurality of speakers 18 through the audio processing units 22. The pre-set time alignment, gain and frequency values for each tuning profile are stored within a look-up table within the controller 20 to allow the controller 20 to apply the appropriate values when a tuning zone 34A, 34B, 34C, 34D is identified.

In the exemplary embodiment shown in FIG. 1, the environment 14 is the interior of an automobile 16 that includes four seats 30. The automobile 16 includes the driver seat 30A, the front passenger seat 30B and left and right rear seats 30C, 30D. The controller 20 will identify one of the four pre-determined tuning zones 34A, 34B, 34C, 34D based on the location of the occupants. If only the driver seat 30A is occupied, the controller 20 will select a first tuning zone 34A. If both the driver seat 30A and the front passenger seat 30B are occupied, the controller 20 will select a second tuning zone 34B. If passengers are present in either or both of the rear seats 30C, 30D, a third tuning zone 34C is selected by the controller 20. Based on the tuning zone 34A, 34B, 34C, 34D identified by the controller 20, the controller 20 will automatically adjust output characteristics of each of the plurality of speakers 18 to optimized the sound for the identified tuning zone 34A, 34B, 34C, 34D.

When the first tuning zone 34A is identified, the controller 20 will automatically adjust the output characteristics of each of the plurality of speakers 18 to optimize the sound for the driver of the automobile 16. When the second tuning zone 34B is identified, the controller 20 will automatically adjust the output characteristics of each of the plurality of speakers 18 to optimize the sound for both the driver and the front passenger of the automobile 16. When the third tuning zone 34C is identified, the controller 20 will automatically adjust the output characteristics of each of the plurality of speakers 18 to optimize the sound for the entire interior of the automobile 16.

In another exemplary embodiment, the controller 20 is adapted to allow an occupant to selectively over-ride the automatic tuning zone selection and manually select one of the pre-determined tuning zones 34A, 34B, 34C, 34D. For example, the driver of the automobile 16 may manually select a fourth tuning zone 34D, wherein the controller 20 optimizes the sound from the audio entertainment system 10 for only the rear seats 30C, 30D. This would be advantageous when the driver of the automobile 16 is not interested in what the passengers in the rear seats 30C, 30D are listening too.

In an exemplary embodiment, the sensors 32 within the plurality of seats 30 are pressure sensors 32A. A pressure sensor 32A is located within each seat 30, and when an occupant is seated therein, the senor 32A will detect the weight of the occupant seated therein and send a signal to the controller 20 indicating that an occupant is present in that seat 30. These type of sensors 32A could be used in an audio entertainment system 10 for an automobile, or an auditorium/theatre setting.

In another exemplary embodiment, each of the seats 30 includes a seatbelt assembly 36. The sensor 32B within each of the plurality of seats 30 is adapted to detect when the seatbelt assembly 36 of a seat 30 is latched. If the seatbelt assembly 36 is latched, the sensor 32B sends a signal to the controller 20 indicating that the seatbelt assembly 36 is latched, and thus, an occupant is seated within the seat 30.

In still another exemplary embodiment, the environment 14 includes at least one camera 38 mounted therein, in communication with the controller 20, to detect the presence of occupants within the plurality of seats 30. The camera 38 uses image detection technology to identify the presence of occupants within the seats 30 and sends a corresponding signal to the controller 20.

In an exemplary embodiment, the audio entertainment system 10 includes a seat detection module 40 that communicates will the sensors 32A, 32B and the camera 38 to identify where occupants are located within the environment 14. The seat detection module 40 is in communication with the controller 20 and send information gathered from the sensors 32A, 32B and the camera 38 to the controller 20. The controller 20 is adapted to continuously evaluate the location of occupants within the environment 14 and adjust the output from the plurality of speakers 18 accordingly. For example, in an automobile 16, if the automobile 16 is stopped, and passengers leave the automobile 16, or passengers within the automobile 16 move around, the controller 20 will receive information from the sensors 32A, 32B within the seats 30 and the camera 38 indicating that the location of occupants within the automobile 16 has changed. Upon the departure or movement of the occupants within the automobile 16, the controller 20 will switch the identified tuning zone 34A, 34B, 34C, 34D as necessary and apply the appropriate associated tuning profile to optimize the output from the plurality of speakers 18 for the new seating locations.

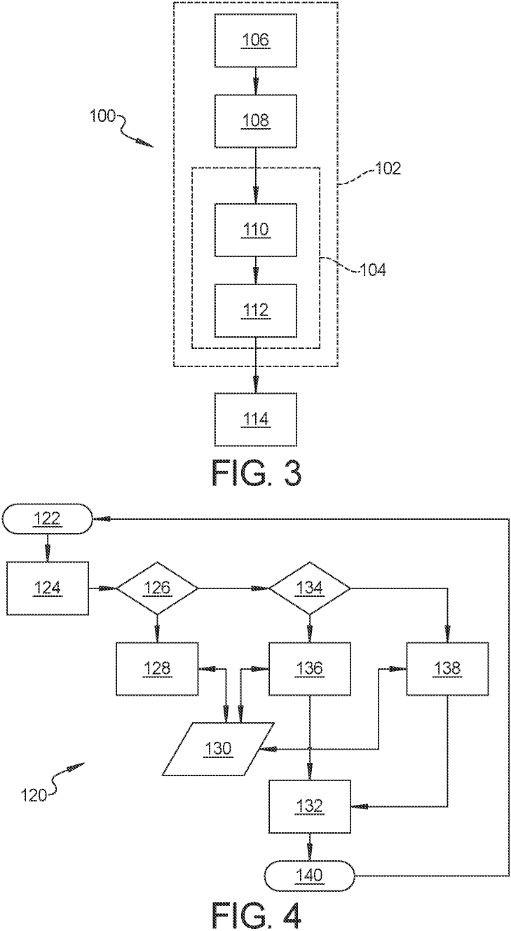

Referring to FIG. 3, a method 100 of adapting an audio entertainment system 10 having an audio infotainment system 12 adapted to provide sound to a plurality of speakers 18 positioned within an environment 14 includes, at block 102, automatically adjusting, with a controller 20, output characteristics of each of the plurality of speakers 18 positioned within the environment 14 based on a location of occupants within the environment 14.

In an exemplary embodiment, each of the plurality of speakers 18 includes an audio processing unit 22 adapted to control the output characteristics of the speaker 18, and each audio processing unit 22 is in communication with the controller 20. At block 104, the method 100 includes automatically adjusting, via communication between the controller 20 and the audio processing unit 22 for each of the plurality of speakers 18, output characteristics of each of the plurality of speakers 18 positioned within the environment 14 based on a location of occupants within the environment.

At block 106, in an exemplary embodiment, the environment 14 includes a plurality of seats 30 and the method 100 includes detecting the presence of occupants within the plurality of seats 30 with sensors positioned within each of the plurality of seats 30. At block 108, the controller 20 receives data from the sensors 32 to determine where occupants within the environment are seated. Once the controller 20 has identified the location of occupants within the environment 14, moving again to block 104, the controller 20 automatically adjusts output characteristics of each of the plurality of speakers 18 positioned within the environment 14 based on the location of occupants within the environment 14.

Automatically adjusting, via communication between the controller 20 and the audio processing unit 22 for each of the plurality of speakers 18, output characteristics of each of the plurality of speakers 18 positioned within the environment 14 based on a location of occupants within the environment 14 further includes, at block 110, identifying, with the controller 20, one of a plurality of pre-determined tuning zones 34A, 34B, 34C, 34D based on the location of occupants within the environment 14 and, moving to block 112, adjusting, with the controller 20, the output characteristics of the plurality of speakers 18 according to a tuning profile associated with the identified tuning zone 34A, 34B, 34C, 34D.

As discussed above, if only the driver seat 30A is occupied, the controller 20 will select the first tuning zone 34A. If both the driver and front passenger seats 30A, 30B are occupied, the controller 20 will select the second tuning zone 34B. If passengers are present in either or both of the rear seats 30C, 30D, the third tuning zone 34C is selected by the controller 20. Based on the tuning zone 34A, 34B, 34C, 34D identified by the controller 20, the controller 20 automatically adjusts output characteristics of each of the plurality of speakers 18 to optimize the sound for the identified tuning zone 34A, 34B, 34C, 34D.

Each tuning profile provides pre-set time alignment, gain and frequency values for each of the plurality of speakers 18 for the associated tuning zones 34A, 34B, 34C, 34D. Adjusting, with the controller 20, the output characteristics of the plurality of speakers 18 according to a tuning profile associated with the identified tuning zone 34A, 34B, 34C, 34D further includes adjusting, with the controller 20, the time alignment, gain and frequency values for each of the plurality of speakers 18 according to the pre-set time alignment, gain and frequency values for each of the plurality of speakers 18 for the identified tuning zone 34A, 34B, 34C, 34D.

In an exemplary embodiment, the environment 14 is an interior of an automobile 16 and the sensors 32 within the seats 30 are pressure sensors 32A adapted to detect the weight of an occupant seated therein, wherein the detecting the presence of occupants within the plurality of seats 30 with sensors 32 positioned within each of the plurality of seats 30 at block 106 further includes, detecting, with the pressure sensors 32A, the presence of occupants within the plurality of seats 30.

In another exemplary embodiment, the environment 14 is an interior of an automobile 16 including a seatbelt assembly 36 associated with each of the plurality of seats 30 within the automobile 16. The sensors 32B are adapted to detect when the seatbelt assembly 36 of a seat 30 is latched, wherein the detecting the presence of occupants within the plurality of seats 30 with sensors 32 positioned within each of the plurality of seats 30 at block 106 further includes, detecting, with the sensors 32B within the seats 30, when the seatbelt assembly 36 of a seat 30 is latched.

In still another exemplary embodiment, the environment 14 is an interior of an automobile 16 including at least one camera 38 mounted therein to detect the presence of occupants within the plurality of seats 30, wherein the detecting the presence of occupants within the plurality of seats 30 with sensors 32 positioned within each of the plurality of seats 30 at block 106 further includes, detecting, with the at least one camera 38, the presence of occupants within the plurality of seats 30.

In yet another exemplary embodiment, the controller 20 is adapted to allow an occupant to over-ride the automatic tuning zone 34A, 34B, 34C, 34D selection and manually select a tuning zone 34A, 34B, 34C, 34D, the method further including, moving to block 114, over-riding, with the controller 20, the automatically selected tuning zone 34A, 34B, 34C, 34D, when an operator manually selects, via the controller 20, a tuning zone 34A, 34B, 34C, 34D.

Referring to FIG. 4, an exemplary embodiment of a method 120 of adapting an audio entertainment system 10 having an audio infotainment system 12 adapted to provide sound to a plurality of speakers 18 positioned within an automobile 16 is illustrated.

Beginning at block 122, each time the automobile 16 is started, the process is triggered and repeats continuously. Moving to block 124, the controller 20 proceeds with gathering information from the sensors 32 within seats 30 within the automobile 16 to determine where occupants are seated within the automobile 16. In this exemplary embodiment, the controller 20 automatically assumes the driver seat 30A is always occupied.

Moving to block 126, if the controller 20 determines that the front passenger seat 30B of the automobile 16 is occupied, then, moving to block 128, the controller 20 identifies the second tuning zone 34B as the desired tuning zone, based on the location of occupants in both the driver seat 30A and the front passenger seat 30B. The controller 20 then pulls the appropriate tuning profile, including pre-set time alignment, gain and frequency values for each of the plurality of speakers 18 for the second tuning zone 34B from a look-up chart stored within the controller 20, at block 130. Moving to block 132, the controller 20 applies the pre-set time alignment, gain and frequency values for the tuning profile associated with the second tuning zone 34B to the audio processing unit 22 at each of the plurality of speakers 18 to optimize the output from the plurality of speakers 18 for the driver and front passenger.

If the controller 20, at block 126, determines that the front passenger seat 30B of the automobile 16 is not occupied, then, moving to block 134, if the controller 20 determines that either of the rear seats 30C, 30D of the automobile 16 are occupied, then, moving to block 136, the controller 20 identifies the third tuning zone 34C as the desired tuning zone, based on the location of occupants in both the driver seat 30A and at least one of the rear seats 30C, 30D. The controller 20 then pulls the appropriate tuning profile, including pre-set time alignment, gain and frequency values for each of the plurality of speakers 18 for the third tuning zone 34C from a look-up chart stored within the controller 20, at block 130. Moving to block 132, the controller 20 applies the pre-set time alignment, gain and frequency values for the tuning profile associated with the third tuning zone 34C to the audio processing unit 22 at each of the plurality of speakers 18 to optimize the output from the plurality of speakers 18 for the driver and rear passengers.

If the controller 20, at block 126, determines that the front passenger seat 30B of the automobile 16 is not occupied, and, at block 134, that the rear seats 30C, 30D of the automobile 16 is not occupied, then, moving to block 138, the controller 20 identifies the first tuning zone 34A as the desired tuning zone, based on the location of an occupant only in the driver seat 30A. The controller 20 then pulls the appropriate tuning profile, including pre-set time alignment, gain and frequency values for each of the plurality of speakers 18 for the first tuning zone 34A from a look-up chart stored within the controller 20, at block 130. Moving to block 132, the controller 20 applies the pre-set time alignment, gain and frequency values for the tuning profile associated with the first tuning zone 34A to the audio processing unit 22 at each of the plurality of speakers 18 to optimize the output from the plurality of speakers 18 for the driver.

Moving to block 140, the method 120 loops back to block 122, wherein the process is started again so the controller 20 continuously monitors the location of occupants within the automobile 16 and will automatically change the identified tuning zone 34A, 34B, 34C, 34D and associated tuning profile if the location of occupants within the automobile 16 changes.

A system 10 and method 100, 120 of the present disclosure offers several advantages. These include automatically optimizing the output from speakers 18 within an environment 14 based on the location of occupants within the environment 14 to provide the best audio to the occupants that are present. In the case of an automobile 16, a driver or passenger does not need to manually adjust an equalizer or tuner, rather the system 10 will automatically detect the location of occupants therein and adjust the output from speakers 18 accordingly, continuously monitor the location of occupants within the automobile 16, and change the output characteristics within the automobile 16 when the location of occupants therein changes.

A system 10 of the present disclosure provides identified tuning zones 34A, 34B, 34C, 34D and associated tuning profiles that provide pre-set output characteristics that may be customized based on user preferences, wherein the system 10 will automatically provide custom audio profiles when certain occupant seating arrangements are detected, or when such custom output characteristics are manually selected.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. An audio entertainment system, comprising:
an audio infotainment system adapted to provide sound to an environment;
a plurality of speakers positioned within the environment and in communication with the infotainment system;
a controller adapted to automatically adjust output characteristics of each of the plurality of speakers based on a location of occupants within the environment;
wherein the controller is adapted to identify one of a plurality of pre-determined tuning zones based on the location of occupants within the environment and to adjust the output characteristics of the plurality of speakers according to a tuning profile associated with the identified tuning zone; and
wherein each tuning profile provides a family of pre-set audio tuning parameters for each of the plurality of speakers for each of the tuning zones.

2. The audio entertainment system of claim 1, wherein each of the plurality of speakers includes an audio processing unit adapted to control the output characteristics of the speaker, each audio processing unit being in communication with the controller.

3. The audio entertainment system of claim 2, further including a plurality of seats positioned within the environment, each of the plurality of seats including a sensor adapted to detect the presence of an occupant seated therein, each of the plurality of sensors in communication with the controller, the controller adapted to receive input from the sensors within the plurality of seats to determine where occupants within the environment are seated.

4-5. (canceled)

6. The audio entertainment system of claim 3, wherein the environment is an interior of an automobile.

7. The audio entertainment system of claim 6, wherein the sensors within the seats are pressure sensors adapted to detect the weight of an occupant seated therein.

8. The audio entertainment system of claim 6, further including a seatbelt assembly associated with each of the plurality of seats within the automobile, wherein the sensors within the seats detect when the seatbelt assembly of a seat is latched.

9. The audio entertainment system of claim 6, further including at least one camera mounted therein, in communication with the controller, to detect the presence of occupants within the plurality of seats.

10. The audio entertainment system of claim 6, wherein the controller is adapted to allow an occupant to selectively over-ride the automatic tuning zone selection and manually select a tuning zone.

11. A method of adapting an audio entertainment system having an audio infotainment system adapted to provide sound to a plurality of speakers positioned within an environment, comprising:
automatically adjusting, with a controller, output characteristics of each of the plurality of speakers positioned within the environment based on a location of occupants within the environment;
identifying, using the controller, one of a plurality of pre-determined tuning zones based on the location of occupants within the environment and to adjust the output characteristics of the plurality of speakers according to a tuning profile associated with the identified tuning zone; and
providing, using the controller, each tuning profile with a family of pre-set audio tuning parameters for each of the plurality of speakers for each of the tuning zones.

12. The method of claim 11, wherein each of the plurality of speakers includes an audio processing unit adapted to control the output characteristics of the speaker, each audio processing unit being in communication with the controller, wherein the automatically adjusting, with a controller, output characteristics of each of the plurality of speakers positioned within the environment based on a location of occupants within the environment further includes automatically adjusting, via communication between the controller and the audio processing unit for each of the plurality of speakers, output characteristics of each of the plurality of speakers positioned within the environment based on a location of occupants within the environment.

13. The method of claim 12, wherein the environment includes a plurality of seats positioned therein, the method further including:
detecting the presence of occupants within the plurality of seats with sensors positioned within each of the plurality of seats;
receiving data from the sensors, with the controller, and determining where occupants within the environment are seated, prior to automatically adjusting, with a controller, output characteristics of each of the plurality of speakers positioned within the environment based on a location of occupants within the environment.

14. The method of claim 13, wherein the automatically adjusting, via communication between the controller and the audio processing unit for each of the plurality of speakers, output characteristics of each of the plurality of speakers positioned within the environment based on a location of occupants within the environment further includes identifying, with the controller, one of a plurality of pre-determined tuning zones based on the location of occupants within the environment and adjusting, with the controller, the output characteristics of the plurality of speakers according to a tuning profile associated with the identified tuning zone.

15. The method of claim 14, wherein each tuning profile provides a family of pre-set audio tuning parameters for each of the plurality of speakers for each of the tuning zones, wherein the adjusting, with the controller, the output characteristics of the plurality of speakers according to a tuning profile associated with the identified tuning zone further includes adjusting, with the controller, the audio tuning parameter values for each of the plurality of speakers according to the pre-set audio tuning parameter values for each of the plurality of speakers for the identified tuning zone.

16. The method of claim 15, wherein the environment is an interior of an automobile and the sensors within the seats are pressure sensors adapted to detect the weight of an occupant seated therein, wherein the detecting the presence of occupants within the plurality of seats with sensors positioned within each of the plurality of seats further includes, detecting, with the pressure sensors, the presence of occupants within the plurality of seats.

17. The method of claim 15, wherein the environment is an interior of an automobile including a seatbelt assembly associated with each of the plurality of seats within the automobile, the sensors adapted to detect when the seatbelt assembly of a seat is latched, wherein the detecting the presence of occupants within the plurality of seats with sensors positioned within each of the plurality of seats further includes, detecting, with the sensors within the seats, when the seatbelt assembly of a seat is latched.

18. The method of claim 15, wherein the environment is an interior of an automobile including at least one camera mounted therein to detect the presence of occupants within the plurality of seats, wherein the detecting the presence of occupants within the plurality of seats with sensors positioned within each of the plurality of seats further includes, detecting, with the at least one camera, the presence of occupants within the plurality of seats.

19. The method of claim 15, wherein the controller is adapted to allow an occupant to over-ride the automatic tuning zone selection and manually select a tuning zone, the method further including over-riding, with the controller, the automatically selected tuning zone, when an operator manually selects, via the controller, a tuning zone.

20. An automobile having audio entertainment system, comprising:
an audio infotainment system adapted to provide sound to an environment within the automobile;
a plurality of speakers positioned within the environment and in communication with the infotainment system, each of the plurality of speakers including an audio processing unit adapted to control the output characteristics of the speaker;
a plurality of seats positioned within the environment, each of the plurality of seats including a sensor adapted to detect the presence of an occupant seated therein, each sensor being at least one of a pressure sensor adapted to detect the weight of an occupant seated therein and a sensor adapted to detect when a seatbelt assembly of the seat is latched;
at least one camera mounted therein to detect the presence of occupants within the plurality of seats;
a controller in communication with each of the audio processing units and with each of the sensors within the seats, the controller adapted to receive input from the sensors within the plurality of seats to determine where occupants within the environment are seated, to identify one of a plurality of pre-determined tuning zones based on the location of occupants within the environment, and to automatically adjust the output characteristics of the plurality of speakers according to a tuning profile associated with the identified tuning zone, wherein each tuning profile provides pre-set audio tuning parameter values for each of the plurality of speakers for each of the tuning zones, the controller further adapted to allow an occupant to selectively over-ride the automatic tuning zone selection and manually select a tuning zone.

21. The audio entertainment system of claim 6, wherein each tuning profile has pre-set time alignment, gain and frequency values stored within a look-up table within the controller to allow the controller to apply the appropriate values when the tuning zone is identified.

22. The automobile of claim 20, wherein each tuning profile has pre-set time alignment, gain and frequency values stored within a look-up table within the controller to allow the controller to apply the appropriate values when the tuning zone is identified.
